(19) United States
(12) Patent Application Publication
(10) Pub. No.: US 2021/0393041 A1
(43) Pub. Date: Dec. 23, 2021

(54) THERAPEUTIC DEVICE FOR EXTREMETIES

(71) Applicants: Marcia EVANS, Prospect Park, NJ (US); Norman LAWRENCE, Prospect Park, NJ (US)

(72) Inventors: Marcia EVANS, Prospect Park, NJ (US); Norman LAWRENCE, Prospect Park, NJ (US)

(21) Appl. No.: 17/403,001

(22) Filed: Aug. 16, 2021

Related U.S. Application Data
(63) Continuation-in-part of application No. 15/057,334, filed on Mar. 1, 2016.

(51) Int. Cl. A47C 20/00; A61G 7/075

(52) U.S. Cl. CPC A47C 20/021; A47C 20/025; A61G 2200/12; A61G 7/0755

(57) ABSTRACT

A therapeutic device is provided for where the therapeutic device made up of a unitary elongated piece having a distal end and a proximate end, where the distal end is the unitary elongated piece that is in a configuration to provide an elevated landing for lower or upper extremities, and is equipped with a material connected to the elongated piece and extending to a desired length and culminating at the proximate end, where this material implements a supporting means for the upper or lower extremities of a user, provided that these extremities are not resting on the elongated piece.

### CROSS-REFERENCE TO RELATED APPLICATIONS SECTION

This application is a U.S. Non-Provisional and Continuation-in-Part (CIP) Patent Application that claims priority to U.S. Non-Provisional patent application Ser. No. 15/057,334 filed on Mar. 1, 2016, the entire contents of which are hereby incorporated by reference in their entirety.

### FIELD OF THE EMBODIMENTS

The invention and its embodiments relate to a therapeutic device for use with a user's extremities. In particular, the present invention relates to a therapeutic device for extremities that enables the easy and comfortable elevation of a user's extremities while the device remains stationary.

### BACKGROUND OF THE EMBODIMENTS

Edema can occur throughout the entirety of a person's body and is the body's natural response to injury or inflammation. That the, medications, pregnancy, infections, cirrhosis, and many other events can also cause edema. Frequently, this swelling occurs in a person's feet, ankles, and/or legs, and is the result of the abnormal build-up of fluids in the tissues of one's ankles and legs. Edema displays itself by causing “pitting.” That is, when pressure is applied to an affected area of the body, the pressure will result in a “pit” that takes considerable amount of time to be refilled with fluid by the body, as opposed to the immediate return to its normal shape in healthy humans.

Generally, there are six factors that contribute to the formation of edema: (1) reduced oncotic pressure within blood vessels; (2) increased hydrostatic pressure; (3) obstructions of fluid clearance in the lymphatic system; (4) increased tissue oncotic pressure; (5) increased blood vessel wall permeability; and (6) change in the water retaining properties of the a person's tissues. As can be inferred from the above disclosure, a variety of competing factors exist that can cause edema. While some of these factors, such as factor 3, cannot be addressed without medication, other factors, such as factors 1, 2, and 5, can be addressed with simple, non-pharmaceutical techniques. For example, by propping an affected area of the body up for a period of time, many of the symptoms of edema can be addressed. Specifically, it has been shown that by elevating a part of the body suffering from edema above heart level, venous draining and reduced swelling is promoted. Preferably, the part of the body is not raised more than 45 degrees and not more than 8-12 inches above the heart. While this may go on indefinitely, whenever resting, a user should engage in this preferably for a period of time. Further, the frequency with which this is done has an effect on the amount of swelling. Additionally, efforts taken to avoiding sitting or standing without moving for extended periods of time has an effect on this. As such, there is a need for a device that enables people to quickly, comfortably, and securely raise an extremity above the heart level, in a variety of situations and while on the go.

Examples of related art are as follows:

U.S. Pat. No. 5,173,979 discloses an inflatable cushion apparatus for maintaining a person's lower leg, ankle and foot, in an elevated and substantially horizontal position relative to the person's head and upper body. The inflatable cushion apparatus includes an angled front wall for supporting a person's upper leg in an inclined position. A top wall is provided which extends horizontally when the apparatus is inflated. A valve is provided to facilitate filling of the cushion apparatus.

U.S. Pat. No. 5,448,790 discloses a wide variety of cushion support arrangements for the body of a human user, for example, adults and children who have experienced neuro-muscular damage, are provided by the selective use and positioning of individual body support cushions comprising an inclined wedge cushion, an alternate form of an inclined wedge cushion, a relatively thick multi- purpose block cushion, a double inclined cushion, a relatively thin block cushion, an abductor block cushion, and half cylinder rolls or rail cushions of various axial lengths.

U.S. Pat. No. 6,175,979 discloses an inflatable orthopedic pillow having both a size and shape effective to maintain elevation of one or both of a patient's lower extremities to a position favorable for the reduction of chronic edematous swelling. The shape and construction of the device provides an area effective for the isolation of a patient's foot so that the heel and surrounding area is floating in midair. At the same time, the entire leg is cradled upon an inflated surface which yields to pressure and thus minimizes the formation of secondary ulcers due to prolonged periods of contact of the surrounding tissues with the device.

U.S. Pat. No. 6,578,218 discloses a pillow having a pivoting butterfly structure with two cushions pivotably interconnected by a hinge element to pivot between an open position and a closed position. Each cushion has a hinge end adjacent the hinge element, and a connecting end disposed at the end of the cushion opposite the hinge end. A middle portion is located between the hinge end and connecting end of each cushion. The cushions have a relatively flat inner surface and a curved contoured surface that extend the length of each cushion. The contoured surface projects away from the inner surface and forms two peaks near the hinge end and connecting end of each cushion. Between the peaks, the contoured surface curves inward back toward the inner surface and forms a concave groove near the middle portion of each cushion. A cover encases both cushions and contours the shapes of the cushions.

U.S. Patent Publication No.: 2008/0092297 discloses a pillow formed of a resilient body and having an hourglass shape for placing between a person's legs to provide support while the person is reclining. The pillow can include a massaging unit disposed inside the body for producing vibrations. The pillow in one embodiment has first and second portions pivotally connected along a hinge such that the pillow is convertible between an open configuration and a closed configuration. The pillow can be positioned between the legs when in the closed configuration, or beneath the legs when in the open configuration.

U.S. Patent Publication No.: 2009/0223524 discloses a leg and feet elevator apparatus that should be used for recreational and/or therapeutic purposes. The device is triangular in shape with a right angle design for optimum comfort and multi-positioning; wrapped in an outer cover of durable vinyl/plastic; inflatable composite material and heat sealed envelopes that give the device its wedge effect for comfort and support of the legs and feet. On either side of the center surface are air diffusers which allow air to diffuse from the center surface to comfort and support the legs and feet. The elevating wedge operates to elevate the legs and feet at an angle comfortable for lounging in a semi-upright position for many recreational and therapeutic purposes. This is a cost efficient device that everyone can afford. Other embodiments are described and shown.

U.S. Patent Publication No.: 2013/0062922 discloses a therapeutic leg elevation device and an associated treatment method are disclosed. The device includes a first inclined surface for supporting a patient's thigh and that tilts the thigh at an angle above horizontal that is also less than an angle that can kink the femoral vein. A second inclined surface supports the patient's lower leg and also tilts the lower leg above the horizontal at an angle sufficient to permit gravity to augment blood flow. The first and second surfaces define an angle that positions the knee and lower leg at an angle that relaxes the hamstring and gastrocnemius muscle for comfort and prevents the popliteal vein from being compressed by the tibia. The second inclined surface has a limited length that permits a patient's feet to extend over the end of the second surface to prevent pressure on the heel. The device includes an inflatable interior component and a cushion layer covering the inflatable interior component.

Chinese Patent Document No.: CN 201743858 discloses a lower limb edema treatment support for pregnant women comprises a base plate and a foot rest. The utility model is characterized in that an air bag is arranged between the base plate and the foot rest, a guide pipe is arranged on the air bag, the other end of the guide pipe is provided with an inflatable ball, an air intake valve and an air release valve are arranged on the inflatable ball, and the base plate is connected with one end of the foot rest by a movable shaft. When the support is used, the lower limbs of pregnant women are put on the foot rest, and pregnant women can hold the inflatable ball by hand to fill air or release air until feel comfortable. The utility model has the benefits that the treatment support is convenient and practicable, pregnant women can arbitrarily adjust the support by selves, and optimum comfort can be obtained.

Chinese Patent Document No.: CN 203060157 discloses an anti-edema foot support. The foot support comprises a foot support apparatus for supporting the feet of patients and a knee cushion for supporting the legs of the patients, wherein two arc grooves for bearing the feet of the patients are formed on the upper side surface of the foot support apparatus in parallel at intervals, and an adjustable band is arranged on each arc groove and used for fixing the ankles of the patients. The legs and feet of the patients are supported through applying the timing anti-edema foot support, the requirements of different body positions are satisfied at the same time, and limbs are in functional positions, so that the lower limb edema is relieved and prevented. A timer is also arranged to remind of body position change, the patients can freely turn in three body positions (a horizontal position, a left lateral position and a right lateral position), and moreover, the foot support is made from a breathable material and is comfortably used by the patients; and a wrapping cloth can be detached and is convenient to clean and disinfect. Consequently, the anti-edema foot support is not only simple in structure but also convenient to use and clean; and moreover, complications such as pressure sores and venous thrombosis of the patients lying in bed for a long time can be relieved through adopting the anti-edema foot support.

Chinese Patent Document No.: CN 203075095 discloses a bracket capable of preventing lower limbs from edema. The bracket comprises a bottom plate and a leg support, and is characterized in that the bottom plate is connected with one end of the leg support through a movable shaft; the leg support is arc-shaped and the upper surface of the leg support is provided with two semicircles provided with gauzes; the bottom plate is provided with a motor; a main shaft of the motor is provided with a thread and a nut and the nut is internally provided with an inner thread; the leg support is arranged on the nut; the motor is provided with a controller through a lead wire; and the controller is provided with a power supply switch and a forward and reverse change-over switch. When being used, the bracket is placed on a bed and the lower limbs of a pregnant woman are respectively placed on the two semicircular gauzes on the leg support; and the height of the bracket can be adjusted through the controller according to the requirements of the pregnant woman. The bracket disclosed by the utility model has the beneficial effects of being convenient and practical and being randomly adjusted so as to achieve the optimal comfort level.

Chinese Patent Document No.: CN203138943 discloses a multifunctional elevating cushion for lower limbs. The elevating cushion comprises a base portion and four supporting legs. The top surface of the base portion is an inclined plane which inclines along the longitudinal direction of the base portion, the included angle formed between the inclined plane and the horizontal plane is in a range of 15 degrees to 20 degrees, and the four supporting legs are arranged at four corners of the bottom surface of the base portion respectively and connected with the bottom surface of the base portion. According to the elevating cushion, the problems of arrangement of functional positions of lower limbs of patients suffering lower limb fracture, total hip replacement and lower limb external fixators are solved, detumescence of patients is facilitated, deep vein thrombosis is prevented, postoperative complications are reduced, the comfort of the patients is improved, and treatment and nursing operations are facilitated.

Various devices are known in the art. However, their structure and means of operation are substantially different from the present invention. Such devices fail to provide a device that is optimized for multiple extremities, is intended to be easily portable, contains no mechanical parts, and is intended for at-home use and in medical facilities. At least one embodiment of this invention is presented in the drawings below, and will be described in more detail herein.

### SUMMARY OF THE EMBODIMENTS

The present invention provides for a therapeutic device comprising: a unitary elongated piece at the device's distal end that can be configured to provide an elevated landing for lower or upper extremities; and a material connected to the elongated piece and extending to a desired length and culminating at the device's proximate end; the material using a supporting means for the upper or lower extremities which are not resting on the elongated piece and further securing the device to a stationary object, attached to an object, secured to a bed post, and other, not explicitly mentioned solutions. This stationary object may be a bed, a couch, a floor, a therapy table, or a resting place. The therapeutic device is secured underneath a user. The device's supporting means is also being used for the user's entire body.

It is important to note that the unitary elongated piece can be configured to have a round profile shape, a tear-drop profile shape, or any other geometric shape that conforms to the natural curves of a human body. The present invention can be constructed out of a number of materials, however, the device must remain light enough to be easily manipulated by an ordinary adult human user. Further, the present invention must provide enough cushioning to be used for extended periods of time without causing discomfort, and without causing the present invention to deform permanently.

The present invention is also beneficial in improving respiratory safety in women following childbirth.

It is an object of the present invention to provide a means for keeping an extremity elevation device stationary while in use.

It is an object of the present invention to provide a device that provides users relief from edema.

It is an object of the present invention to provide a device that is light-weight and portable.

It is an object of the present invention to provide a device that allows a user to comfortably elevate an extremity of theirs for extended periods of time.

It is an object of the present invention to provide a device that can be used both in-home and in the offices and facilities of healthcare providers.

It is an object of the present invention to provide a device that can be adorned with a sport's team logo.

It is an object of the present invention to provide an inexpensive extremity elevation device that can come in a variety of colors, fabrics, and designs.

### BRIEF DESCRIPTION OF THE DRAWINGS

FIG. 1 shows a perspective view of an embodiment of the present invention.

FIG. 2 shows a front elevation view of an embodiment of the present invention.

FIG. 3 shows a rear elevation view of an embodiment of the present invention.

FIG. 4 shows a left side elevation view of an embodiment of the present invention.

FIG. 5 shows a right side elevation view of an embodiment of the present invention.

FIG. 6 shows a top plan view of an embodiment of the present invention.

FIG. 7 shows a bottom plan view of an embodiment of the present invention.

FIG. 8A shows a perspective view of an embodiment of the present invention, while rolled up.

FIG. 8B shows a perspective view of an embodiment of the present invention, while rolled up in a cover.

FIG. 9 shows a perspective view of an alternative embodiment of the present invention.

FIG. 10 shows a front elevation view of an alternative embodiment of the present invention.

FIG. 11 shows a rear elevation view of an alternative embodiment of the present invention.

FIG. 12 shows a left side elevation view of an alternative embodiment of the present invention.

FIG. 13 shows a right side elevation view of an alternative embodiment of the present invention.

FIG. 14 shows a top plan view of an alternative embodiment of the present invention.

FIG. 15 shows a bottom plan view of an alternative embodiment of the present invention.

FIG. 16 shows a perspective view of an alternative embodiment of the present invention, while rolled up.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

Leg swelling or edema is a common problem that occurs when fluid builds up in the tissues. Most frequently, edema is a result of harmless conditions, but occasionally it is caused by a more serious underlying health problem, such as congestive heart failure, chronic venous disease, kidney disease, or cirrhosis. Common types of edema include: peripheral edema (occurring in the legs or arms), pedal edema (occurring in the feet and lower legs), lymphedema (caused by blockage in or damage to the lymphatic system), pulmonary edema (a serious condition that occurs when fluid collects in the sacs of ones lungs), cerebral edema (a serious condition that occurs when fluid builds up in the brain), and macular edema (occurring when fluids builds up in ones eye). Ultimately, edema occurs when tiny blood vessels in your body (capillaries) leak fluid. The fluid builds up in surrounding tissues, leading to swelling.

Elevating the swollen limb above the heart level can help relieve this type of swelling, as it helps the extra fluid move back towards the heart for circulation to the rest of the body, reduces swelling, and lowers pressure on ones veins. See, Natalie S. Evans, et al., “The swollen leg,” Vascular Medicine, 2016, 21(6), Pages 562-564, DOI: 10.1177/1358863X16672576; John W. Ely, et al., “Approach to leg edema of unclear etiology,” J. Am. Board Fam. Med., March-April 2006, 19(2), Pages 148-160, DOI: 10.3122/jabfm.19.2.148; James G. O'Brien, et al., “Treatment of edema,” American Family Physician, 2005, 71(11), Pages 2111-2117; Julie Stalbow, “Preventing cellulitis in older people with persistent lower limb oedema,” Br. J. Nurs., 2004, 13(12), Pages 725-732, DOI: 10.12968/bjon.2004.13.12.13262; and Emma J. Topham, et al., “Chronic lower limb oedema,” Clin. Med. (Lond.), 2002, 2(1), pages 28-31, DOI: 10.7861/clinmedicine.2-1-28, the entire contents of which are hereby incorporated by reference in their entirety. Thus, the instant invention allows the user to elevate a swollen limb above the heart level of the user to reduce edema.

In some embodiments, the present invention is used for purely recreational use, while in other embodiments it is suitable for preventing sleep apnea and assists in alleviating symptoms of other upper respiratory disorders, such as asthma, chronic obstructive pulmonary disease (COPD), chronic bronchitis, emphysema, cystic fibrosis/bronchiectasis, pneumonia, etc.. For example, researchers have shown that head of bed elevation (HOBE) reduces obstructive sleep apnea severity. See, R. D. McEvoy, et al., “The effects of posture on obstructive sleep apnea,” Am Rev Respir Dis., 1986, 133, Pages 662-666; A. M. Neill, et al., “Effects of sleep posture on upper airway stability in patients with obstructive sleep apnea,” Am J Respir Crit Care Med., 1997, 155, Pages 199-204, DOI: 10.1164/ajrccm.155.1.9001312; and F. F. Souza, et al., “The influence of bedhead elevation on patients with obstructive sleep apnea [abstract] Am J Respir Crit Care Med., 2011, 183, Pages A2732-A2732, DOI: 10.1164/ajrccm-conference.2011.183.1_meetingabstracts.a2732, the entire contents of which are hereby incorporated by reference in their entirety. Specifically, HOBE decreases upper airway collapsibility and increases the upper airway area, as compared to supine position. See, S. E. Martin, et al., “The effect of posture on airway caliber with the sleep-apnea/hypopnea syndrome,” Am J Respir Crit Care Med., 1995, 152, Pages 721-724, DOI: 10.1164/ajrccm.152.2.7633733, the entire contents of which are hereby incorporated by reference in their entirety.

Researchers have also shown that HOBE is a commonly used therapeutic intervention in patients with pneumonia, as HOBE has also been shown to improve oxygenation and hemodynamic performance. See, Amy J. Spooner, et al., “Head-of-Bed Elevation Improves End-Expiratory Lung Volumes in Mechanically Ventilated Subjects: A Prospective Observational Study,” Respiratory Care, 2014, 59 (10) 1583-1589; DOI: https://doi.org/10.4187/respcare.02733, the entire contents of which are hereby incorporated by reference in their entirety. As described herein, haemodynamics or hemodynamics are the dynamics of blood flow. The circulatory system is controlled by homeostatic mechanisms of autoregulation. The haemodynamic response continuously monitors and adjusts to conditions in the body and its environment. Haemodynamics explains the physical laws that govern the flow of blood in the blood vessels.

Thus, the instant invention allows for elevation of a body part of a user to reduce edema, alleviate or prevent sleep apnea, and/or alleviate upper respiratory disorders.

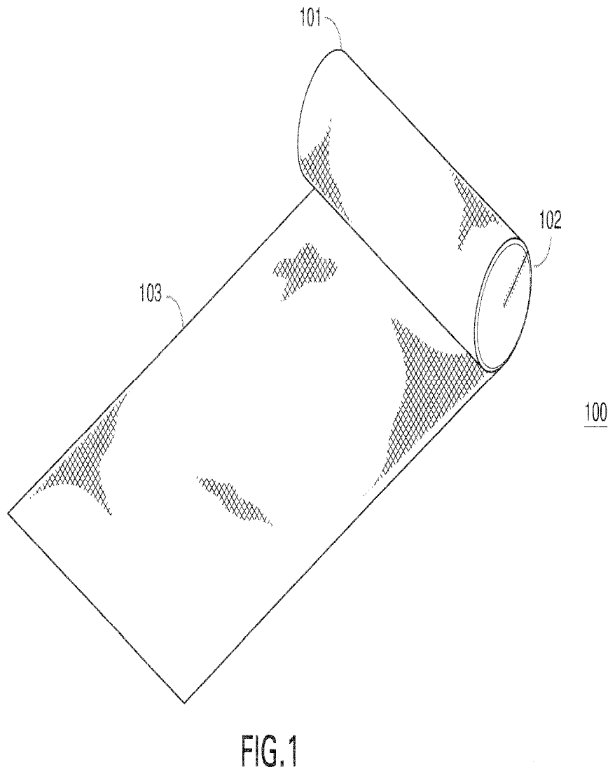

Referring to FIG. 1, a perspective view of an embodiment of the present invention is shown. Here, therapeutic device 100 is comprised of unitary elongated piece 101, having configuration 102, and material 103 connected to elongated piece 101. Here configuration 102 is in the shape of a circle. While therapeutic device 100 can be operated in a number of different ways, it is preferably operated by placing therapeutic device 100 on a stationary object, such as a bed, a couch, or a floor. Any stationary object will do, provided that the object is sized such that a user can achieve their desired position.

Once therapeutic device 100 has been placed on a stationary object, a user will then place an extremity affected by edema or leg swelling onto elongated piece 101. Elongated piece 101 will preferably be constructed out of foam, but any material that can support the weight of the user's extremity while substantially maintaining its shape is suitable for use in the present invention. Some non-limiting examples of suitable include memory foam, latex foam, nylon foam, Styrofoam, fabric padding, and other similar materials. This elongated piece 101 is connected to material 103.

Preferably, elongated piece 101 has a height of 12″-16″, although it can be sized to correspond to a given user's proportions. More preferably, elongated piece 101 will have a height that allows a user's extremity to be 8″-12″ above the user's heart line while in use.

The inclusion of material 103 serves two purposes. One purpose is to provide a cushioning means for a user as material 103 is preferably underneath a user when therapeutic device 100 is in use. The amount of cushioning will depend on what material 103 is constructed out of, and how thick material 103 is manufactured. Material 103 may be constructed out of nylon, cotton, lycra, silk, wool, polyester, sating, leather, velvet, denim, chino, and the like.

Material 103 can be as thin as a single piece of fabric, but can be as thick as 5 inches, depending on user preference, provided that when in use, a user's extremity is of sufficient height above the heartline.

The other purpose of material 103 is to allow therapeutic device to remain stationary while in use. Much of the prior art has no means of ensuring that the device stays stationary, or if the device does have some fixing means, they are overly cumbersome or meant solely for industrial use. In stark contrast, material 103 offer a simple, robust solution to this problem that is visually pleasing and provides for a means for the device to remain stationary in both residential and industrial settings. Material 103 operates by being connected permanently to unitary elongated piece 101 or by being removably connected to the unitary elongated piece 101 through the removable attachment 104. When a user places their extremity onto unitary elongated piece 101, they should position themselves that all or a portion of their body rests on material 103. The weight of the user will prevent therapeutic device 100 from shifting, allowing a user to more easily maintain the therapeutic position.

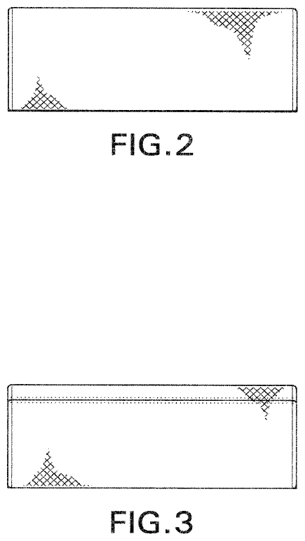

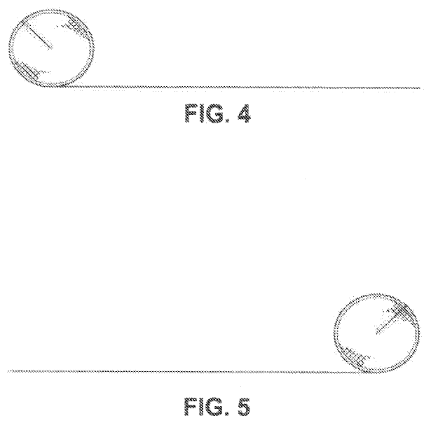

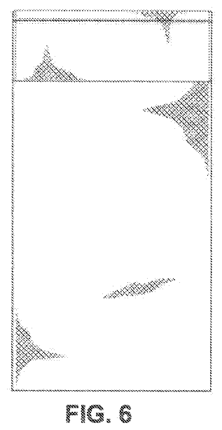

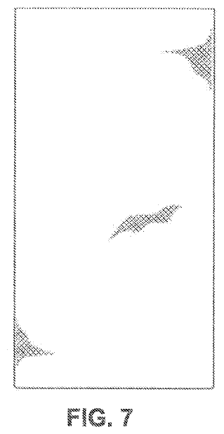

FIGS. 2-7 show various views of the embodiment of therapeutic device 100 shown in FIG. 1. These views show that embodiment from a number of different angles, all while therapeutic device 100 is in the elongated position.

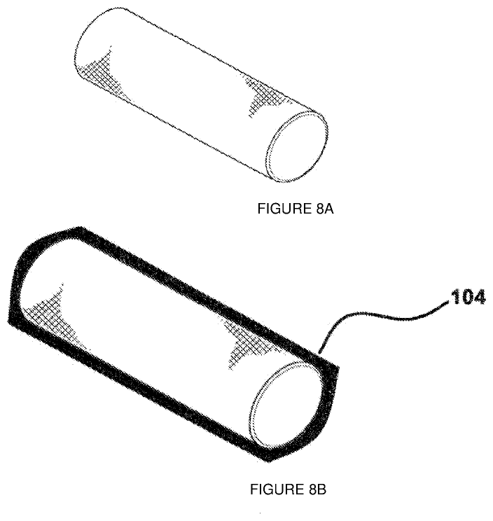

FIG. 8A and FIG. 8B show a perspective view of an embodiment of the present invention, while rolled up. This is the position that therapeutic device 100 will take while being transported and/or stored. The ability to roll-up such that therapeutic device 100 takes up considerably less space is a highly beneficial aspect of the present invention. This ability will have applications in any location where space is limited, such as small apartments, local medical practices, or large medical practices where a multitude of devices must be stored when not in use. Further, this ability makes transporting the device (say from a hospital back to a user's residence) significantly easier.

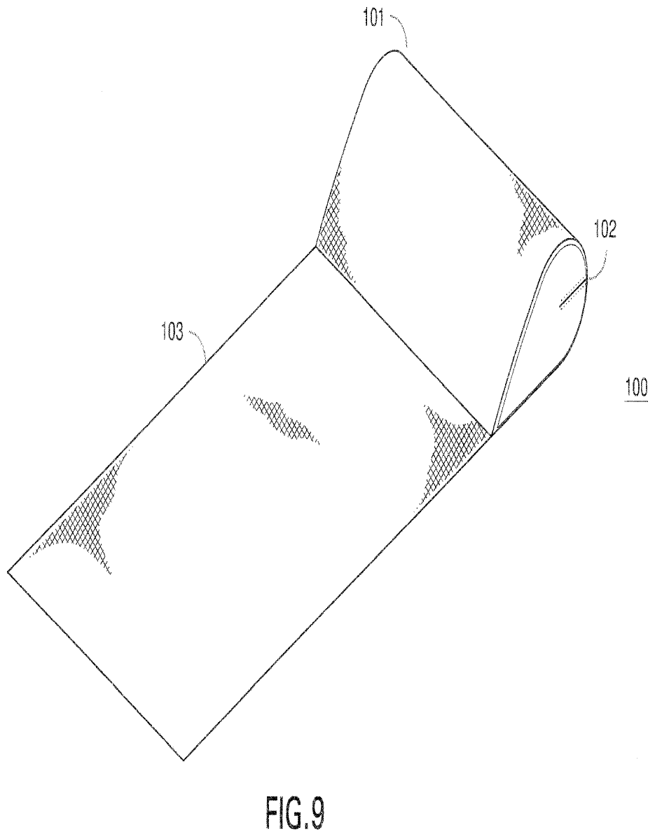

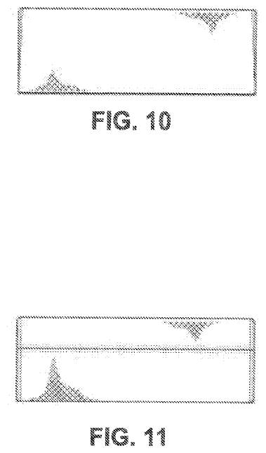

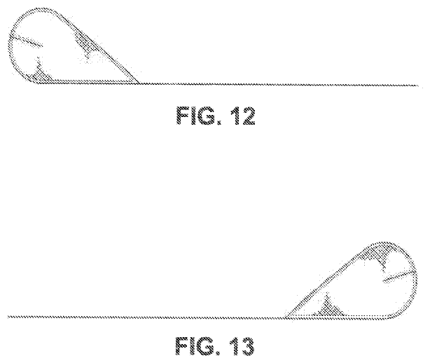

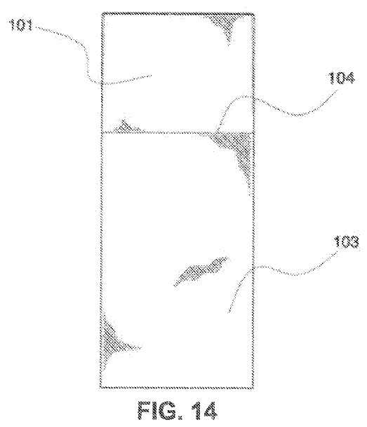

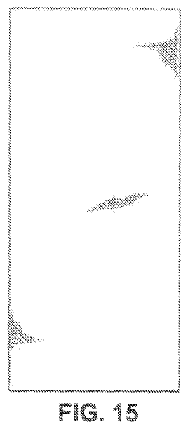

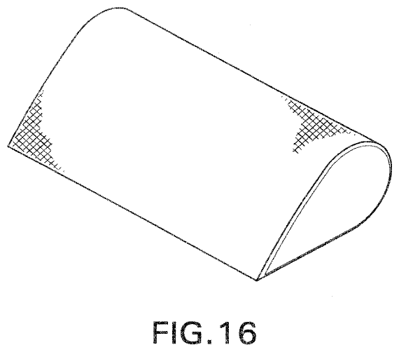

FIGS. 9-16 show various views of an alternative embodiment of the present invention. The primary difference between this embodiment and the embodiment of FIGS. 1-8 is the shape of configuration 102. While in the previously-reference embodiment, configuration 102 is circular in shape, here configuration 102 is in a tear-drop shape. This has the additional benefit of providing a less steep slope, and providing support throughout the entire elevation structure. That is, while a user resting an extremity on a circular unitary elongated piece, there will be some part of their extremity that is elevated but not supported; this teardrop shape prevents this phenomenon due to the slope that leads to the apex of the curve of the tear drop. Like the previously mentioned embodiments, this embodiment also has the capability of being rolled up such that it may be transported/stored more easily. It should be appreciated that the configuration 102 may comprise another shape that has not been explicitly listed, such as: an oval shape, a rectangular shape, a diamond shape, a half circle shape, a pie slice shape, a square shape, a triangular shape, or a quadrilateral shape, among other shapes not explicitly listed herein.

In a preferred embodiment, the present invention further comprises a cover 104 that can envelop unitary elongated piece 101, material 103, or some combination thereof. This cover 104 can be disposed with a design, a pattern, a logo, an insignia, and can be made out of any fabric suitable for sustained contact with human skin. This cover 104 has the benefit of allowing multiple users to use the device subsequently, without cleaning. This is beneficial in hospital settings, where preventing the spread of communicable diseases is paramount. Further, these covers 104 may make the present invention more aesthetically pleasing, and may make it more suitable for use with children or the mentally infirm. In some embodiments, the cover 104 is removable, while in other embodiments the cover 104 is permanently incorporated into the present invention.

In other preferred embodiments, the length of unitary elongated piece 101 can change dramatically. It can be as thin as 6 inches across, but can be as wide as 10 feet across. The 6 inch variant is suitable for use with a single appendage, while the 10 foot variant can be used with multiple users simultaneously. Further, unitary elongated piece 101 can have a variety of heights, based on the degree of elevation required by most users. This height can range from 6 inches up to 2 feet.

In other embodiments, the present invention may comprise a cover 104 with a removable inner cushion. This has the benefit of being more hygienic, and allows for a user to have a number of different designs present on the cover 104 of the present invention, and to easily switch out these designs as desired. Preferably these covers 104 are washable. In another preferred embodiment, the present invention is constructed out of vinyl. This is essential for commercial and institutional use, as well as when multiple users intent to use the device. Being constructed out of vinyl allows the present invention to be easily wiped down between users.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

What is claimed is:

1. A therapeutic device for supporting an entire body of a user, the therapeutic device comprising:
no more than one unitary elongated piece upon which the user can place an upper or lower extremity to reduce symptoms of at least one of edema, an upper respiratory disorder, and a sleep apnea in the user, wherein the elongated piece is situated at a distal end of the therapeutic device and has a height that is adapted to allow the upper or lower extremity of the user to be between 8″ to 12″ above a heart line of the user; and
a substantially flat, cushioning material upon which the user can place the body of the user which is not resting on the elongated piece,
wherein the cushioning material is 5 inches thick,
wherein a height of the elongated piece is greater than 1½ feet,
wherein the elongated piece situated at the distal end of the therapeutic device is connected to the cushioning material that extends to a proximal end of the therapeutic device, and
wherein the elongated piece is rolled upon the cushioning material to reduce a length of the cushioning material for storage of the therapeutic device.

2. The therapeutic device of claim 1, wherein therapeutic device is configured to be placed on a bed, a couch, or a floor.

3. The therapeutic device of claim 1, wherein the therapeutic device is stationary when in use as a result of the body of the user being placed on the cushioning material and the elongated piece.

4. The therapeutic device of claim 1, wherein the elongated piece is capable of having lower or upper extremities with edema rest on it.

5. The therapeutic device of claim 1, wherein the cushioning material is selected from the group consisting of: silk, wool, satin, leather, velvet, denim, and chino.

6. The therapeutic device of claim 1, wherein a material of the elongated piece is selected from the group consisting of: latex foam, nylon foam, Styrofoam, and fabric padding.

7. The therapeutic device of claim 1, wherein the elongated piece is removably connected to the cushioning material.

8. The therapeutic device of claim 1, wherein the elongated piece is permanently connected to the cushioning material.

9. The therapeutic device of claim 1, wherein the elongated piece is configured to have a tear-drop profile shape or a circular shape.

10. The therapeutic device of claim 1, further comprising:
a cover configured to envelope the elongated piece and/or the cushioning material.

11. The therapeutic device of claim 10, wherein the cover is removably attached to the elongated piece and/or the cushioning material.

12. The therapeutic device of claim 12, wherein the cover is permanently attached to the elongated piece and/or the cushioning material.

13. The therapeutic device of claim 1, wherein the height of the elongated piece is 2 feet.

14. The therapeutic device of claim 1, wherein the elongated piece is up to 10 feet across.

15. A therapeutic device for supporting an entire body of a user, the therapeutic device comprising:
a unitary elongated piece upon which the user can place an upper or lower extremity to reduce symptoms of at least one of edema, an upper respiratory disorder, and a sleep apnea in the user, wherein the elongated piece is situated at a distal end of the therapeutic device and has a height that is adapted to allow the upper or lower extremity of the user to be between 8″ to 12″ above a heart line of the user; and
a substantially flat, cushioning material upon which the user can place the body of the user which is not resting on the elongated piece,
wherein the cushioning material is 5 inches thick,
wherein the cushioning material comprises silk, wool, satin, leather, velvet, denim, and/or chino,
wherein a height of the elongated piece is greater than 1½ feet,
wherein the elongated piece situated at the distal end of the therapeutic device is connected to the cushioning material that extends to a proximal end of the therapeutic device,
wherein the elongated piece is configured to have a tear-drop profile shape,
wherein a material of the elongated piece comprises latex foam, nylon foam, Styrofoam, or fabric padding,
wherein the elongated piece is removably connected to the cushioning material, and
wherein the elongated piece is rolled upon the cushioning material to reduce a length of the cushioning material for storage of the therapeutic device, and
a cover configured to envelope the elongated piece and/or the cushioning material, wherein the cover is removably attached to the elongated piece and/or the cushioning material.

16. The therapeutic device of claim 15, wherein the elongated piece is capable of having lower or upper extremities with the edema rest on it.
